(19) United States
(12) Patent Application Publication
(10) Pub. No.: US 2008/0172636 A1
(43) Pub. Date: Jul. 17, 2008

(54) USER INTERFACE FOR SELECTING MEMBERS FROM A DIMENSION

(75) Inventor: Eric S. Danas, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/622,959

(22) Filed: Jan. 12, 2007

(51) Int. Cl. G06F 3/048; G06F 17/30

(52) U.S. Cl. 715/835; 707/3; 707/E17.061

(57) ABSTRACT

For a multi-dimensional database, members of the dimension are displayed using names of the members of the dimension and property information associated with each of the members of the dimension. A selection interface to select at least one member of the dimension is provided while continuing to display the members of the dimension. An indication that the at least one selected member has been selected is also provided. In other implementations, a search of the members of the dimension based on a search condition is executed and members of the dimension that satisfy the search conditions are displayed while continuing to display the members of the dimension.

### BACKGROUND

Multidimensional databases often contain dimensions consisting of a large number of dimension members. If the database, for example, is for a manufacturing or distributing company, the database may include dimensions such as products, customers, geographical regions, and financial accounts. These dimensions may contain many members that are often organized into hierarchies and may include complex organizational structures.

When interacting with information systems built upon a multi-dimensional database, a very common task is the selection of dimension members. When the dimension is large, the task of selecting dimension members can be difficult, as finding the desired dimension member may be challenging.

### SUMMARY OF THE INVENTION

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure is directed to computer-implemented methods, a computer readable medium and a user interface for selecting members from a dimension of a database. Specifically, the members of a dimension are presented along with various selection options that allow members of the database to be easily selected while still viewing information associated with the dimension itself. While viewing information about the members of the dimension, members can be searched. Results of the search, as well as the members of the dimension, may be simultaneously displayed.

In an implementation of a computer-implemented method, members of the dimension are displayed using names of the members of the dimension and property information associated with each of the members of the dimension. A selection interface to select at least one member of the dimension is provided while continuing to display the members of the dimension. An indication that the at least one selected member has been selected is also provided.

In an implementation of a computer readable medium, members of a dimension are displayed in a window. A search of the members of the dimension is executed based on a search condition and members of the dimension that satisfy the search condition are flagged. The flagged members of the dimension are displayed in the window. A selection interface to select at least one member of the dimension is provided and the at least one selected member of the dimension is indicated in the window.

In an implementation of a user interface for a computer system, the interface includes a window to display members of a dimension by displaying names of the members of the dimension, displaying property information associated with members of the dimension, indicating members of the dimension that are selected, and indicating members of the dimension that have been found in response to an executed search. The interface also includes a selection interface to select at least one member of the dimension as well as a search interface to search the members of the dimension based on a search condition.

These and other features and advantages will be apparent from reading the following detailed description and reviewing the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

In the drawings, like numerals represent like elements. In addition, the first digit in three-digit reference numerals and the first two-digits in four-digit reference numerals refer to the figure in which the referenced element first appears.

FIG. 1 is a block diagram of an operating environment for implementations of computer-implemented methods and user interfaces as herein described;

FIGS. 2-11 are screen displays of an interface for selecting members of a dimension;

FIG. 12 is a flow diagram illustrating an exemplary process for handling user input;

FIG. 13 is a flow diagram illustrating an exemplary process for generating search results;

FIG. 14 is a flow diagram illustrating an exemplary process for manually selecting members;

FIG. 15 is a flow diagram illustrating an exemplary process for selecting members from search results;

FIG. 16 is a flow diagram illustrating an exemplary process for executing a selected member action;

FIG. 17 is a flow diagram illustrating an exemplary process for updating a display.

### DETAILED DESCRIPTION OF IMPLEMENTATIONS

This detailed description describes implementations of a user interface for selecting members of a dimension of a database. Generally, members of the dimension are displayed. A search may be conducted on the members, and the members of the dimension that are returned also displayed. Members of the dimension may be selected, either from the general list of the members of the dimension, or from the search results. A list of the selected members may also be displayed, while continuing to display the general list of members and the search results.

### Illustrative Operating Environment

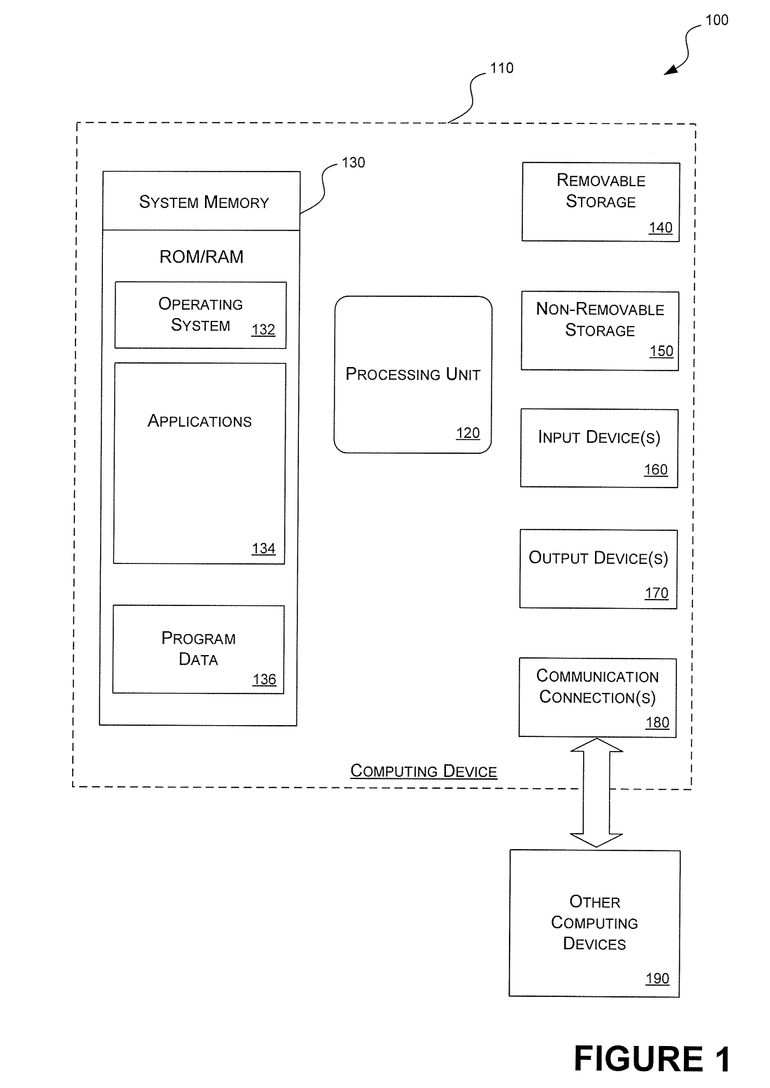

Implementations of displaying a user interface for selecting members of a dimension of a database may be supported by a number of electronic or computerized devices to handle the underlying database, either locally or over a network. FIG. 1 is a block diagram of a representative operating environment 100.

Referring to FIG. 1, an exemplary operating environment 100 includes a computing device, such as computing device 110. In a basic configuration, computing device 110 may include a stationary computing device or a mobile computing device. Computing device 110 typically includes at least one processing unit 120 and system memory 130. Depending on the exact configuration and type of computing device, system memory 130 may be volatile (such as RAM), non-volatile (such as ROM, flash memory, and the like) or some combination of the two. System memory 130 typically includes operating system 132, one or more applications 134, and may include program data 136.

Computing device 110 may also have additional features or functionality. For example, computing device 110 may also include additional data storage devices (removable and/or non-removable) such as, for example, magnetic disks, optical disks, or tape. Such additional storage is illustrated in FIG. 1 by removable storage 140 and non-removable storage 150. Computer storage media may include volatile and non-volatile, removable and non-removable media implemented in any method or technology for storage of information, such as computer readable instructions, data structures, program modules or other data. System memory 130, removable storage 140 and non-removable storage 150 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 110. Any such computer storage media may be part of device 110. Computing device 110 may also have input device(s) 160 such as a keyboard, mouse, pen, voice input device, touch input device, etc. Output device(s) 170 such as a display, speakers, printer, etc. may also be included.

Computing device 110 also contains communication connection(s) 180 that allow the device to communicate with other computing devices 190, such as over a network or a wireless network. Communication connection(s) 180 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

### Interface For Selecting Members From A Dimension

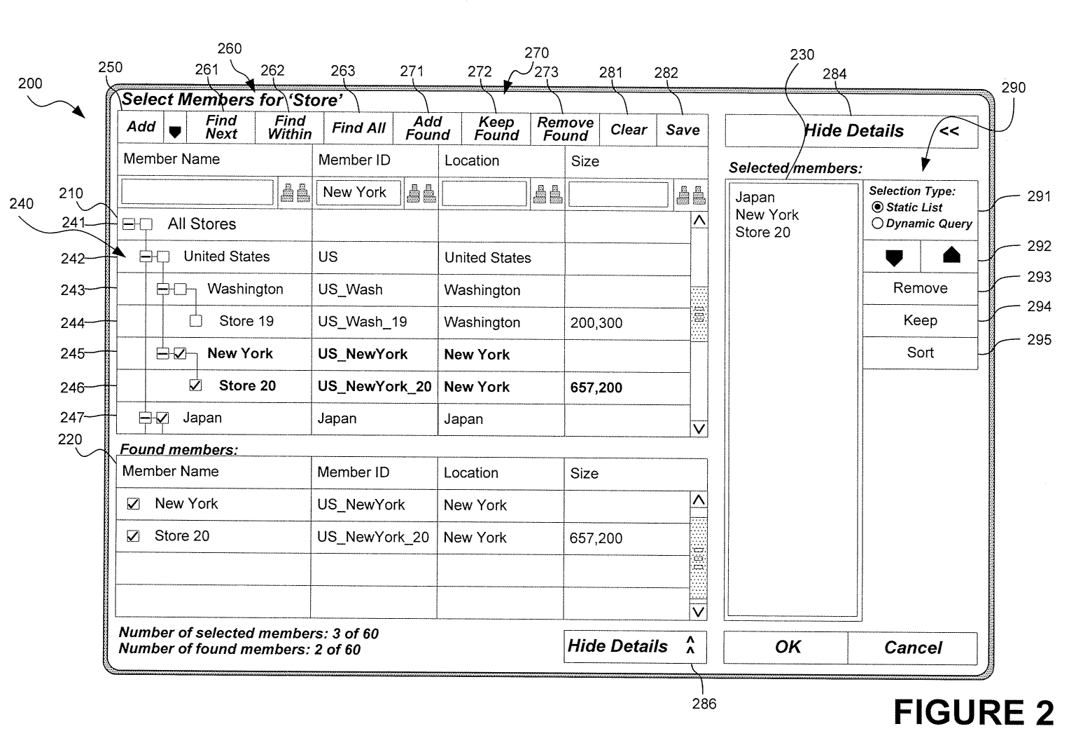

Implementations of a user interface for selecting members from a dimension of a database are described in relation to FIGS. 2-11. In some implementations, the underlying database may be a multidimensional database. In other implementations, the underlying database may be a relational database where a relational table is presented as a dimension. In still other implementations, the underlying database may be arranged in any other configuration known to one of skill in the art.

FIG. 2 shows a screen display showing a window 200 illustrating an exemplary implementation that contains three panes: a members pane 210, a found members pane 220, and a selected members pane 230. The members pane 210 displays members 240 of a dimension that includes members 241-247. In this example, the dimension contains information that represents the stores owned by a particular company. The members 240 have property information associated with them that may be displayed in the members pane 210.

The window 200 may also include additional features. Search controls 260 may also be provided. The search controls 260 may include a Find Next button 261, a Find Within button 262 and a Find All button 263. Select options 270 may also be provided. The select options 270 may include an Add Found button 271, a Keep Found button 272, and a Remove Found button 273.

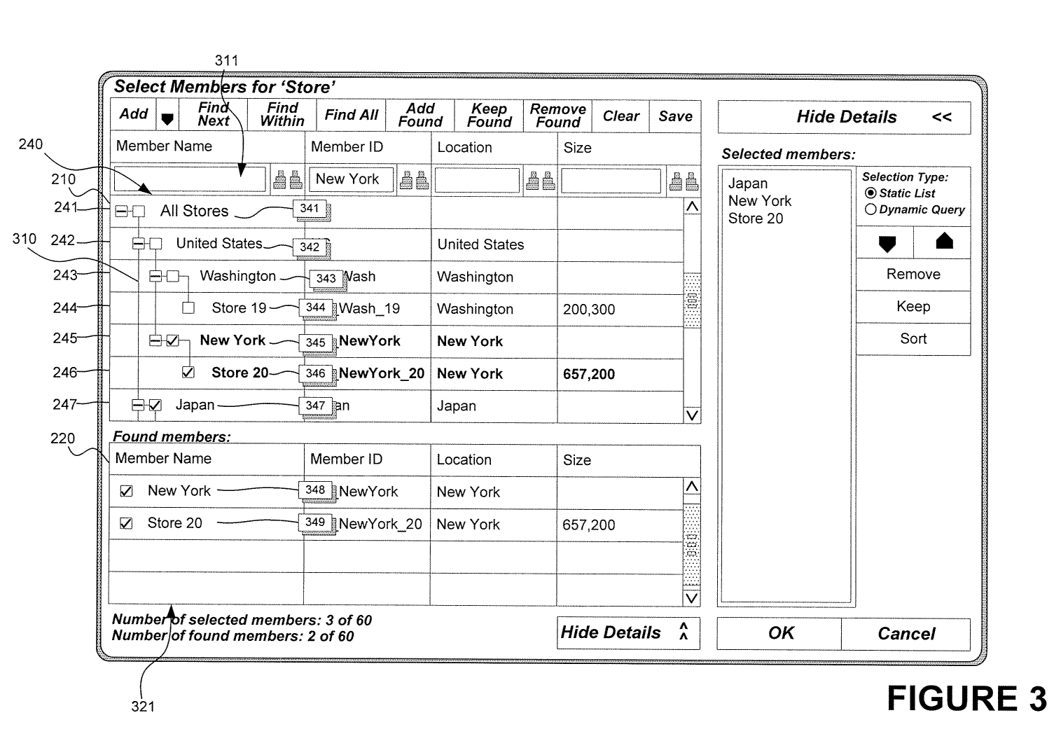

As shown in FIG. 3, the members 240 may have member names 341-347 associated with them. For example, in a member name column 311 of the members pane 210, the names 341-347 of each member may be displayed. Further, as also shown in the member name column 311, a hierarchical relationship 310 between the members 240 may be indicated. That is, members may have children, siblings, parents and other relationships that are indicated in the name column 311.

In this example, the members 240 contain the parent member All Stores 241. The member All Stores 241 contains several children, such as the member United States 242 and the member Japan 247. Further, the member United States 242 contains two children: the member Washington 243 and the member New York 245. Further still, the member Washington 243 contains the child member Store 19 244 and the member New York 245 contains the child member Store 20 246. Thus, the member United Sates 242 contains two grandchildren: the member Store 19 244 and the member Store 20 246. This hierarchical relationship between members is, for exemplary purposes, indicated graphically as a tree 310 in the member name column 311. In other examples, this relationship may be indicated in a different column textually, or not be indicated at all.

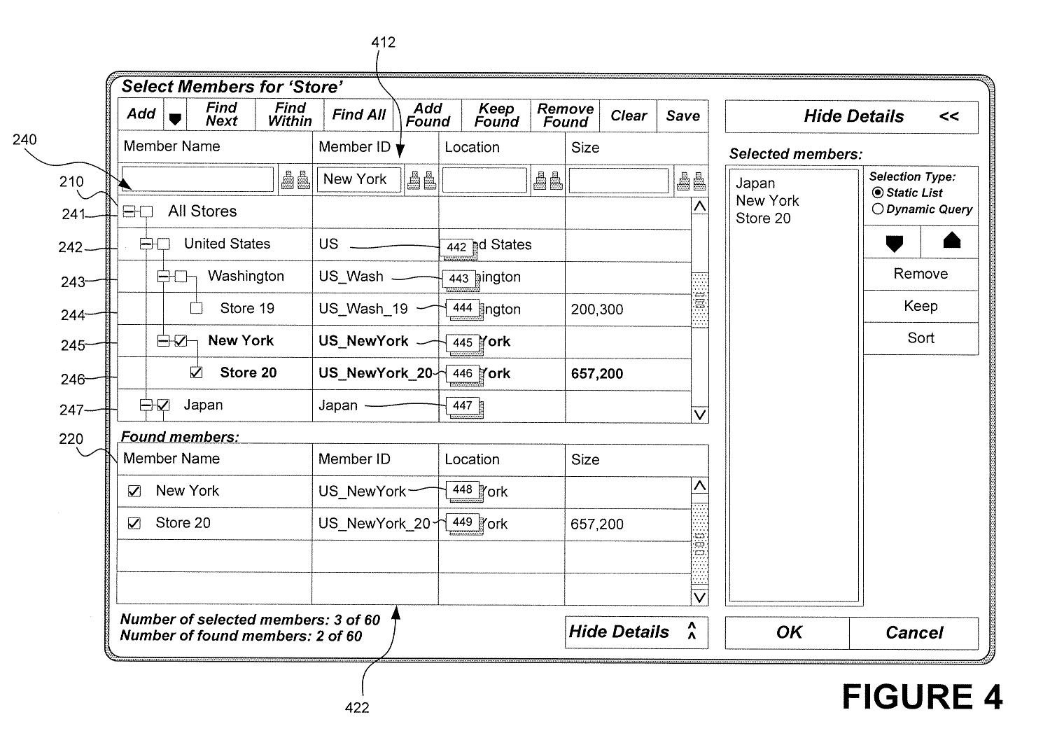

As shown in FIG. 4, the members pane 210 may also display other information associated with the members. For example, the members pane 210 contains a member ID column 412. The member ID column 412 displays IDs 442-447 associated with the members 240. Some members may have an ID associated with them and other members may not. Here, the member All Stores 241 does not have an ID associated with it and thus, in a cell associated with the member All Stores 241, no information is displayed in the member ID column 412. In contrast, the member United States 242 does have an ID 442 associated with it and thus, in a cell associated with the member United States 242 “US” is displayed in the member ID column 412.

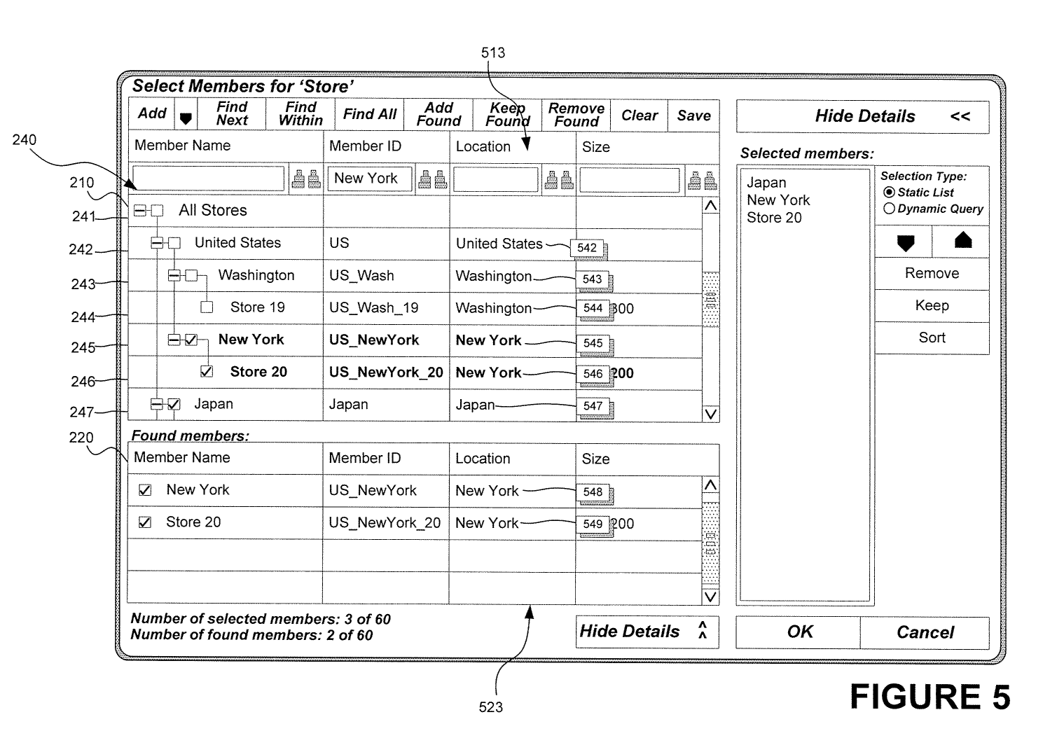

As shown in FIG. 5, the members pane 210 may also display other information associated with the members. For example, the members pane 210 contains a member location column 513. The member location column 513 displays locations 542-547 associated with the members 240. Some members may have a location associated with them and other members may not. Here, the member All Stores 241 does not have a location associated with it and thus, no information is displayed in the member location column 513. In contrast, the member United States 242 does have a location 542 associated with it and thus, in a cell associated with the member United States 242 “United States” is displayed in the member location column 513.

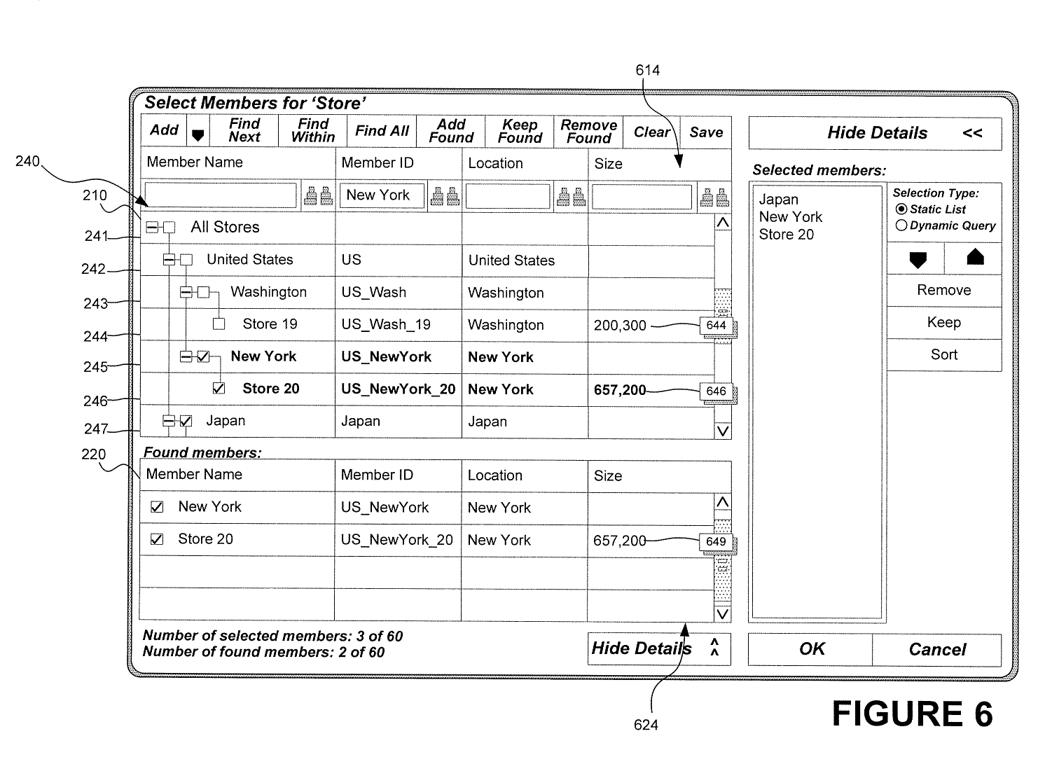

As shown in FIG. 6, the members pane 210 may also display other information associated with the members. For example, the members pane 210 contains a member size column 614. The member size column 614 displays sizes 644 and 646 associated with the members 240. Some members may have a size associated with them and other members may not. Here, the member Washington 243 does not have a size associated with it and thus, in a cell associated with the member Washington 243, no information is displayed in the member size column 614. In contrast, the member Store 19 244 does have a size 644 associated with it and thus, in a cell associated with the member Store 19 244 “200, 300” is displayed in the member size column 614.

### Searching Members

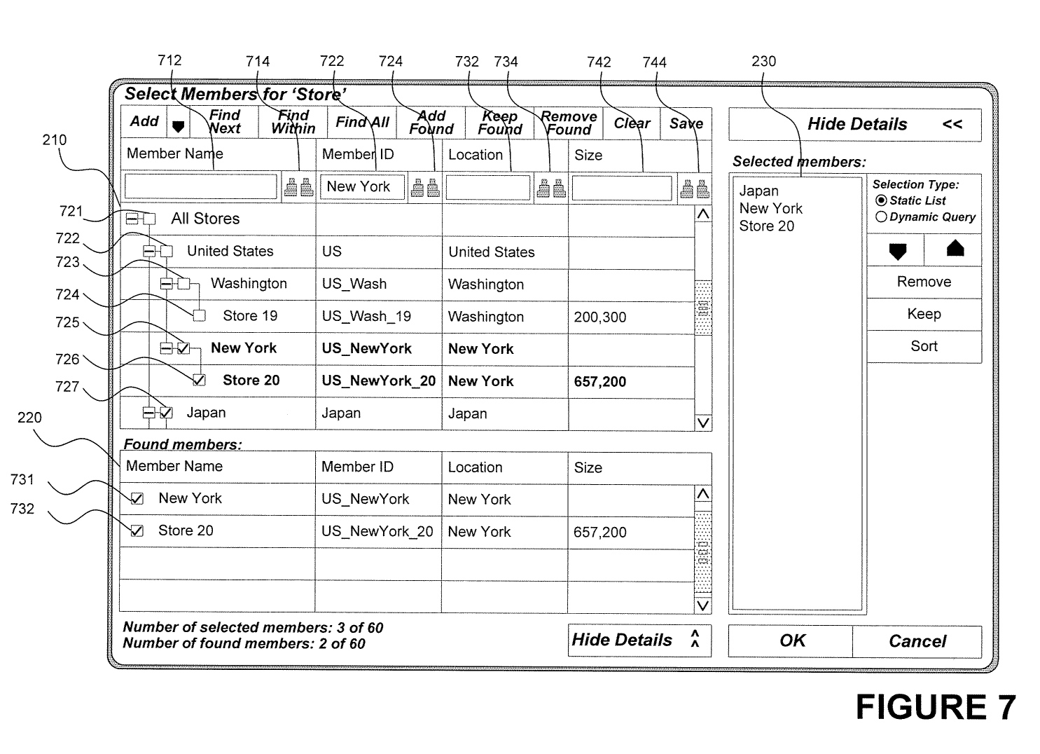

FIG. 7 shows exemplary search controls 712, 714, 722, 724, 732, 734, 742 and 744 that the members pane 210 may also display for searching the members 240. These search controls may allow searching of any of the information associated with the members 240 or may only allow searching of specific information associated with the members. These search controls may also allow the user to define whether a search applies to all information associated with the members 240 or only specific information associated with the members 240. For example, text input areas 712, 722, 732 and 742 allow text to be inputted in their associated columns 211, 212, 213, and 214. Further, search buttons 714, 724, 734, and 744 may be provided to allow the searching of columns 211, 212, 213 and 214 for the text inputted in text input areas 712, 722, 732 and 742 respectively. In other embodiments, any one of search buttons 714, 724, 734, and 744 may allow the searching of all of the columns 211, 212, 213, and 214.

Find option controls 260 may also be used to input desired find options to determine which members are to be flagged when a search is conducted. Find options may also be used to define the relation between the members flagged amongst all of the members that match the find criteria discussed below. A user may input the desired find options through the use of the find option controls 260. For example, find options may require that all members that match the find criteria be flagged by selecting a Find All button 263, only the first member found that matches the find criteria be flagged by selecting a Find Next button 261, or only members previously flagged that also match the find criteria be flagged by selecting a Find Within button 262.

In addition to find options, find criteria may also be applied when a search is conducted. Find criteria may be used to define the relation between the text inputted and the result desired. For example, find criteria may require that information associated with a member must begin with the inputted text, must contain the inputted text, must end with the inputted text, or other standard find criteria known to those skilled in the art.

For example, as shown in FIG. 7, a user may wish to search for members that are located in New York. Thus, the user may input “New York” into the text input area 732 located in the member location column 513 and click on the corresponding search button 734. The user may then set the find criteria such that member location contains the string “New York.” The user may further set the find options to flag all members that match the find criteria by clicking the Find All button 263. In this example, two members would be found: the member New York 245 and the member Store 20 246.

Once a search has been conducted, the members pane 210 may indicate which of members 240 are flagged as found. For example, members that are flagged may be displayed in bold face characters, as the member New York 245 and the member Store 20 246 are displayed in FIG. 7. In other examples, an icon may be used to indicate a member is flagged. In still other examples, text based indication may be used to indicate a member is flagged.

In addition, members that are flagged may be displayed in the found members pane 220. For example, as shown in FIG. 3, in a found member name column 321 of the found members pane 220 the names 348-349 of each found member may be displayed. Further, as shown in FIG. 4, the found members pane 220 may contain a found member ID column 422. The found member ID column 422 displays IDs 448-449 associated with the found members in a similar manner to that of the members pane 210. Here, the found members New York 245 and Store 20 both have IDs 448 and 449 respectively associated with them. Thus, in a cell associated with the member New York 245, “US_NewYork” is displayed and in a cell associated with the member Store 20 246 “US_NewYork_{—}20” is displayed in the member ID column 422.

The found members pane 220 may also display other information associated with the found members. For example, the found members pane 220 may contain a found member location column 523. As shown in FIG. 5, the found member location column 523 displays locations 548-549 associated with the found members in a manner similar to that of the members pane 210. Here, both the found members New York 245 and Store 20 have locations 548 and 549 associated respectively with them. As such, in a cell associated with the member New York 245 “New York” is displayed and in a cell associated with the member Store 20 246 “New York” is displayed in the member ID column 523.

The found members pane 220 may also display other information associated with the members. For example, the found members pane 220 may contain a found member size column 624. As shown in FIG. 6, the found member size column 624 displays sizes 648-469 associated with the found members in a similar manner to that of the members pane 210. Here, the found member New York 245 does not have a size associated and thus, in a cell associated with the found member New York 245, no information is displayed in the found member size column 624. In contrast, the found member Store 20 246 does have a size 649 associated with it and thus, in a cell associated with the member Store 20 246 “657, 200” is displayed in the found member size column 624.

### Selection of Members

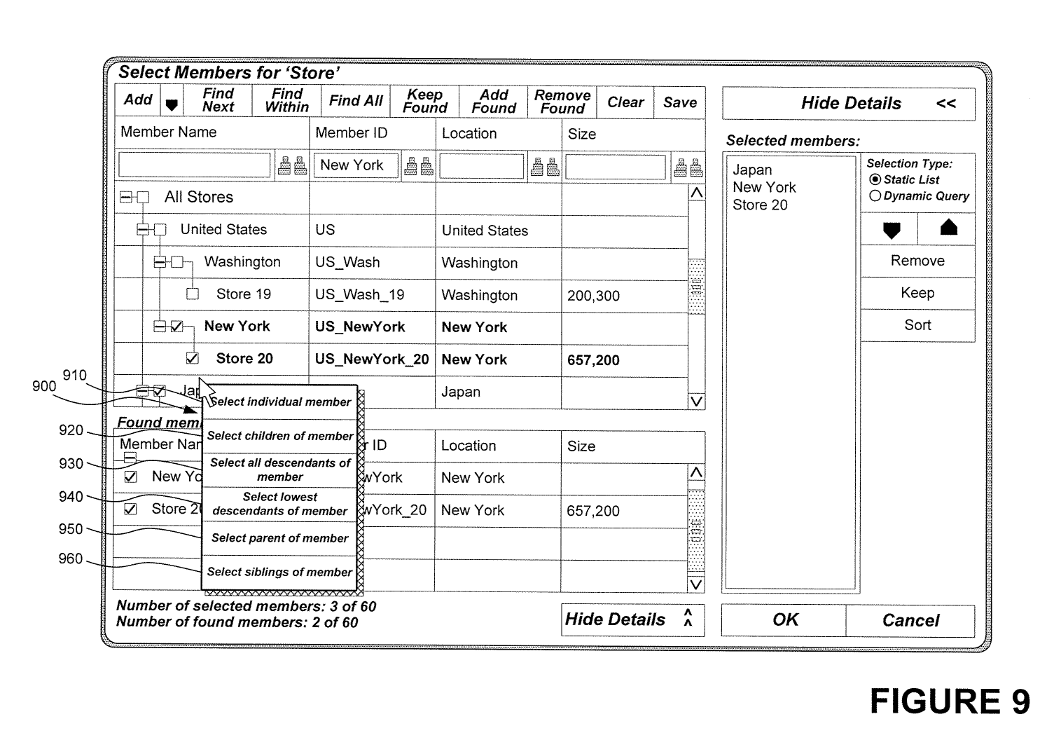

The window 200 also contains various interface elements for allowing a user to select the members 240. For example, the members 240 may be individually selected through use of an add button 250, a context menu 900 (FIG. 9), or through found member selection controls 270. Each interface element may also allow the selection based on a number of select options.

A user may indicate which member should be selected by, for example, first clicking with a mouse pointer on the member to highlight it. In other examples, a user may first click on multiple members so that multiple members are highlighted. Once highlighted, the user may then manually select the members through the use of the add button 250.

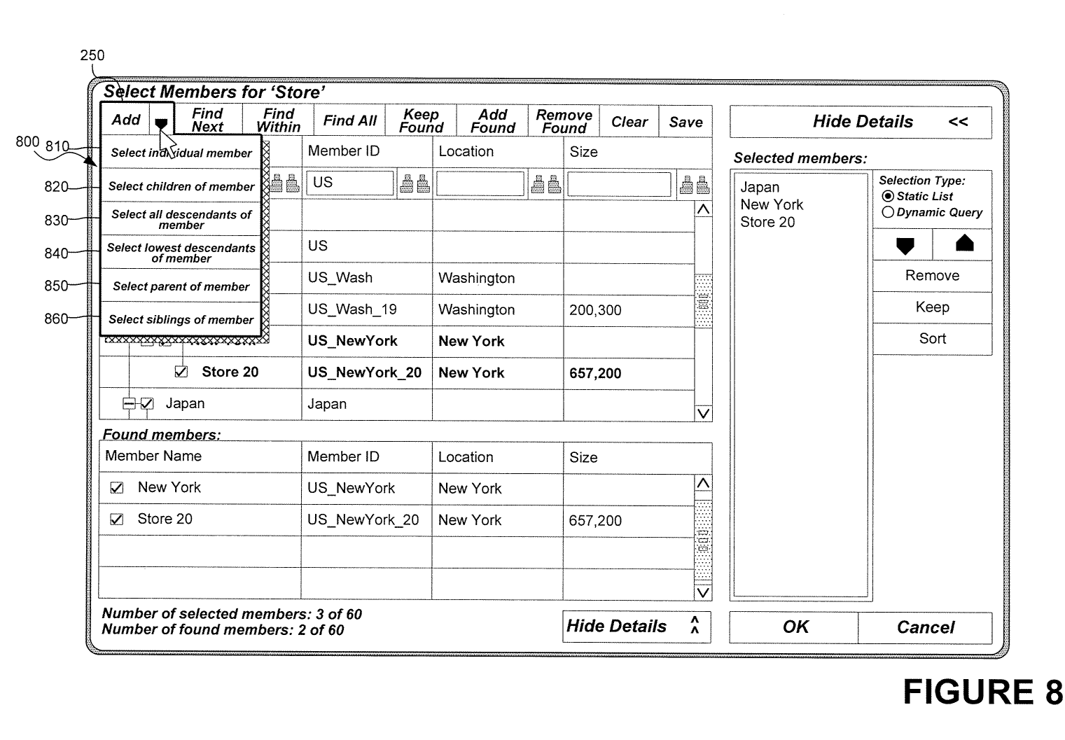

As shown in FIG. 8, the add button 250 may present the user with various selection options 800 through use, for example, of a split button. These select options 800 control the relation between the member to be manually selected and the highlighted member. The user may choose the “Select individual member” option 810 to select the highlighted member. For example, if the member United States 242 is highlighted, and the “Select member” option 810 is selected, the member United States 242 will then be selected.

The user may also choose a “Select children of member” option 820 to select the immediate children of the highlighted member. For example, if the member United States 242 is highlighted, and the “Select children of member” option 820 is selected, the member Washington 243 will then be selected. In other examples, both the highlighted member and its children may be selected.

The user may also choose a “Select all descendants of member” option 830 to select all descendants beneath a highlighted member. For example, if the member United States 242 is highlighted, and the “Select all descendants of member” option 830 is selected, both the member Washington 243 and the member Store 19 244 will then be selected. In other examples, both the highlighted member and its descendants may be selected.

The user may also choose a “Select lowest descendants of member” option 840 to select the lowest descendants of a highlighted member. For example, if the member United States 242 is highlighted, and the “Select lowest descendants of member” option 840 is selected, the member Store 19 244 will then be selected. In other examples, both the highlighted member and its lowest descendants may be selected. In still other examples, if multiple lowest descendants are present, multiple lowest descendants may be selected.

The user may also choose a “Select parent of member” option 850 to select the parent of a highlighted member. For example, if the member Washington 243 is highlighted, and the “Select parent of member” option 850 is selected, the member United States 242 will then be selected. In other examples, both the highlighted member and its parent may be selected.

The user may also choose a “Select siblings of member” option 860 to select the siblings of a highlighted member. For example, if the member Washington 243 is highlighted, and the “Select siblings of member” option 860 is selected, the member New York 245 will then be selected. In other examples, if multiple siblings are present, the multiple siblings of the highlighted member may be selected. In still other examples, both the highlighted member and its siblings may be selected. In other examples, other select options may be available such that a member may be selected based on different relationships between a highlighted member and other members of the dimension.

As shown in FIG. 9, a member may be selected by right clicking on it with a mouse pointer to bring up a context menu 900 associated with that member. The context menu 900 may contain various select options to control selection of the associated member. These select options may function similarly to that of the select options 800 of the add button 250. The user may choose the “Select individual member” option 910 to select the member associated with the context menu. For example, if the member United States 242 is right clicked, and the “Select member” option 910 is selected, the member United States 242 will then be selected.

The user may also choose a “Select children of member” option 920 to select the immediate children of the member associated with the context menu. For example, if the member United States 242 is right clicked, and the “Select children of member” option 920 is selected, the member Washington 243 will then be selected. In other examples, both the member associated with the context menu and its children may be selected.

The user may also choose a “Select all descendants of member” option 930 to select all descendants beneath the member associated with the context menu. For example, if the member United States 242 is right clicked, and the “Select all descendants of member” option 930 is selected, both the member Washington 243 and the member Store 19 244 will then be selected. In other examples, both the member associated with the context menu and its descendants may be selected.

The user may also choose a “Select lowest descendants of member” option 940 to select the lowest descendants of a member associated with the context menu. For example, if the member United States 242 is right clicked, and the “Select lowest descendants of member” option 940 is selected, the member Store 19 244 will then be selected. In other examples, both the member associated with the context menu and its lowest descendants may be selected. In still other examples, if multiple lowest descendants are present, multiple lowest descendants may be selected.

The user may also choose a “Select parent of member” option 950 to select the parent of a member associated with the context menu. For example, if the member Washington 243 is right clicked, and the “Select parent of member” option 950 is selected, the member United States 242 will then be selected. In other examples, both the member associated with the context menu and its parent may be selected.

The user may also choose a “Select siblings of member” option 960 to select the siblings of a member associated with the context menu. For example, if the member Washington 243 is right clicked, and the “Select siblings of member” option 960 is selected, the member New York 245 will then be selected. In other examples, if siblings are present, the multiple siblings of the member associated with the context menu may be selected. In still other examples, both the member associated with the context menu and its siblings may be selected. In other examples, other select options may be available such that a member may be selected based on different relationships between the member associated with the context menu and other members of the dimension.

As shown in FIG. 2, selection controls 270 may also be provided to select a member. The selection controls 270 may include an Add Found button 271, a Keep Found button 272, and a Remove Found button 273. Rather than a selection based on a relation to other members, the selection controls 270 may allow a selection based on the results of a search. For example, a user may run a search that flags the member New York 245 and the member Store 20 246. The user may click the Add Found button 271 to select the members flagged. In the above example, both the member New York 245 and member Store 20 246, as being flagged, would then also be selected.

A user may also click the Keep Found button 272 to keep selected only the members flagged. For example, a user may have previously selected the member New York 245, the member Store 20 246 and the member Japan 247 and run a search that flags only the member New York 245 and the member Store 20 246, but not the member Japan 247. If the user then clicks the Keep Found button 272, the member Japan 247 would be unselected because it was not flagged. On the other hand, the member New York 245 and the member Store 20 246 would remain selected because they were both flagged.

A user may also click the Remove Found button 273 to unselect the members flagged. For example, a user may have previously selected the member Japan 247, the member New York 245 and the member Store 20 246 and run a search that flags only the member New York 245 and the member Store 20 246, but not the member Japan 247. If the user then clicks the Remove Found button 273, the member New York 245 and the member Store 20 246 would be unselected because they were both flagged. On the other hand, the member Japan 247 would remain selected because it was not flagged.

In addition to a user controlling selection based on relation to a highlighted member, based on relation to a member right clicked or based on relation to the results of a search a user may also control selection independent of such relations. For example, a clear button 281 may be provided that unselects all selected members. The clear button 281 may unselect members independent of which member is highlighted, right clicked, or flagged.

### Displaying Selected Members

As shown in FIG. 7, the selection status of the members 240 may be indicated in a variety of ways. Once members are selected, the members pane 210 may indicate which of the members 240 are selected. For example, members that are selected may contain a check box icon 721-727 that is checked, as the check box icons 725, 726 and 727 are. In other examples, selection may be indicated through font format. In still other examples, text based indication may be used to indicate a member is selected.

Members that are selected may also be indicated in the found members pane 220. For example, members that are selected may also contain a check box icon 731-732 that is checked, as the check box icons 731 and 732 are. In other examples, selection may be indicated through font format. In still other examples, text based indication may be used to indicate a member is selected.

Further, members that are selected may be displayed in the selected members pane 230. The selected members pane 230 may also display other information related to the members 240 that are selected. For example, the names of the member New York 245, the member Store 20 246 and the member Japan 247 are shown to in the members pane 230. These various mechanisms for indicating which members are selected, allows a user to visualize the current selections in a variety of ways. Thus, the user can quickly see a list of all selected members in the selected members pane 230, determine which of the found members are selected in the found members pane 220, and determine which of all of the members 240 are selected in the members pane 210. Further, this redundancy allows the user to determine which members are selected without the need for the selected window pane 230 or the found window pane 220.

Once selected, various operations may also be performed on the selected members. For example, selected member options controls 290 may be provided. A selection type control 291 may allow the user to specify whether selection is static or dynamic. If the selection type control 291 is set to static, when the contents of members 240 changes, the group of members selected remains unchanged, even if selection is based on relation to other members. Thus, the member selection is static with changes to the underlying database contents.

On the other hand, if the selection type control 291 is set to dynamic, when the contents of members 240 changes, the group of members selected is updated. For example, a user may highlight the member New York 245 and click the add button 250 with the option 820 to select the children of the member New York 245. The member Store 20 246, as a child of the member New York 245 would then be selected. Because the member Store 20 246 is selected dynamically, new members of the dimension that are also children of the member New York 245 would be selected. For example, if the database is updated and a new member is added as a child of the member New York 245, dynamic selection would then automatically select the new member. Thus, the selection dynamically updates with changes to the underlying database contents.

In addition, Move Up/Down buttons 292 may also be provided to allow a user to change the order in which the selected members are displayed in the selected members pane 230. In some situations, such as when creating a report, the order in which the members appear is important. As such, the Move Up/Down buttons 292 may allow a user to reorder the selected members.

A Remove button 293 may also be provided that allows a user to remove a selected member. For example, a user may click on a selected member displayed in the selected members pane 230 to highlight it. Once highlighted, the member could quickly be unselected, and removed from the selected members pane 230, by clicking the Remove button 293. In other examples, a user may highlight multiple members to be unselected.

A Keep button 294 may also be provided that allows a user to keep only specific members selected. For example, a user may click on a selected member displayed in the selected members pane 230 to highlight it. Once highlighted, the other members may quickly be unselected, and be removed from the selected members pane 230, by clicking the Keep button 294. Only the highlighted member would remain selected. In other examples, a user may highlight multiple members such that multiple members remain selected.

A Sort button 295 may be provided to allow a user to further control the order in which members appear. For example, a user may use the Sort button 295 to order the members alphabetically, by a property value, by hierarchical relationship or any other sortable property that members may be associated with. In other example, a blank space may be inserted between members to further assist in controlling the display of members in the selected members pane 230.

A Save button 282 may also be provided so that the user may save the list of selected items. For example, once the user has selected the desired members of the dimension, the selection may be saved for a report. In other examples, a user may begin selecting members, save a partially completed list in order to continue selecting more members at another time.

The window 200 may also provide controls for altering the panes to be displayed. For example, a user may wish to reduce the information presented by not viewing the found members pane 220 or by not viewing the selected members pane 230. As such, a Hide Details button 284 may be provided to control whether the found members pane is displayed. Similarly, a Hide Details button 286 may also be provided to control whether the selected members pane 230 is displayed.

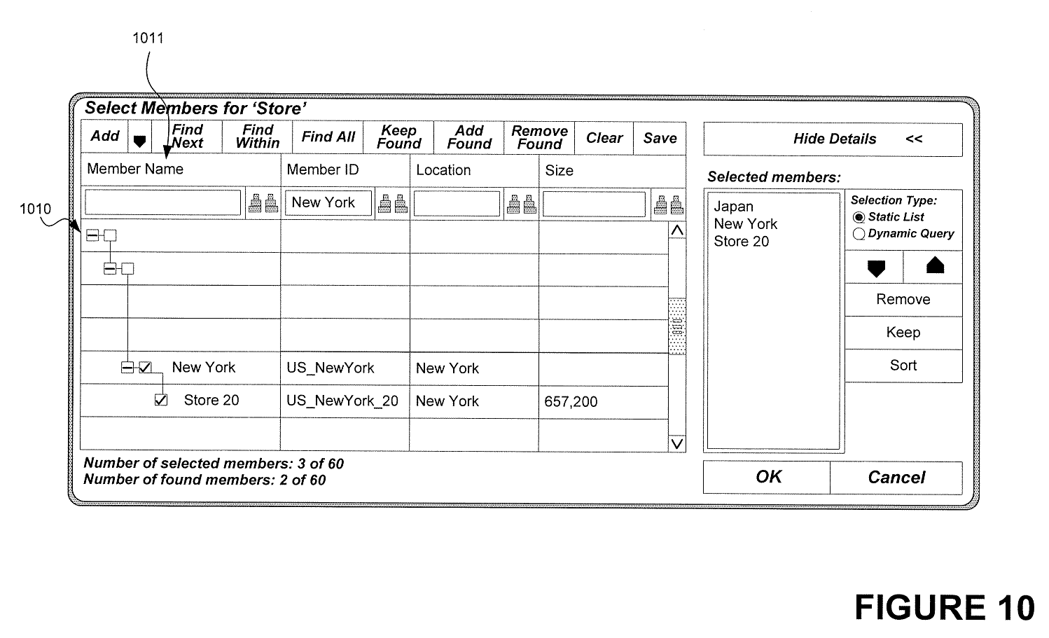

FIG. 10 shows an alternative implementation where the amount of information provided may be reduced though use of an alternative members pane 1010. The members pane 1010 functions in a similar manner as the members pane 210 to display the members 240. As in the example described in relation to the members pane 210, in this example, the dimension contains information that represents the stores owned by a particular company. The members 240 have property information associated with them that may be displayed in the members pane 1010. For example, in a member name column 1011 the name of each member may be displayed. Further, as also shown in the member name column 1011 a hierarchical relationship between the members 240 may be indicated.

Member pane 1010 may function differently from the members pane 210, however, when a search is executed. Rather than indicating the results of a search by bolding members in the members pane 1010 and also displaying them on a separate found members pane, the member pane 1010 displays only members flagged after a search is executed. Thus, the members pane 1010 provides an alternative to the members pane 210 and the found pane 220.

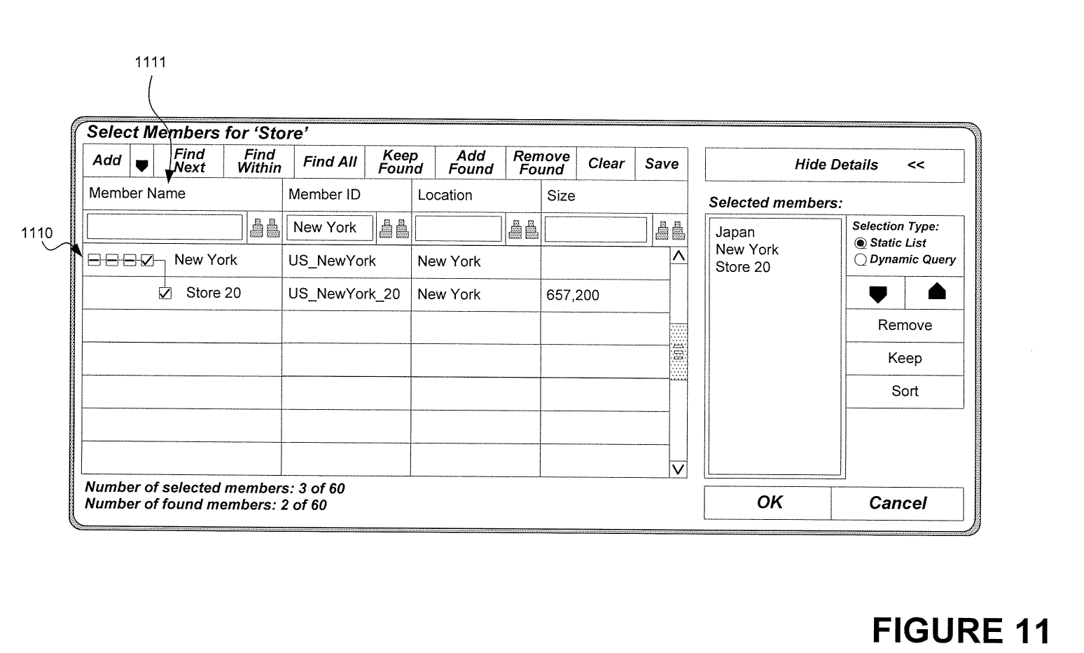

FIG. 11 shows another alternative implementation where the amount of information provided may be reduced though use of an alternative members pane 1110. The members pane 1110 functions in a similar manner as the members pane 1010 to display the members 240. As in the example described in relation to the members pane 1010, in this example, the dimension contains information that represents the stores owned by a particular company. The members 240 have property information associated with them that may be displayed in the members pane 1110. For example, in a members name column 1111 of the members pane 1110 the name of each member may be displayed. In contrast to the member pane 1010, after a search has been executed the member name column may no longer display the hierarchical relationship. This allows less blank space to be used and thus more space-efficiently presents the search results.

### Handling User Input

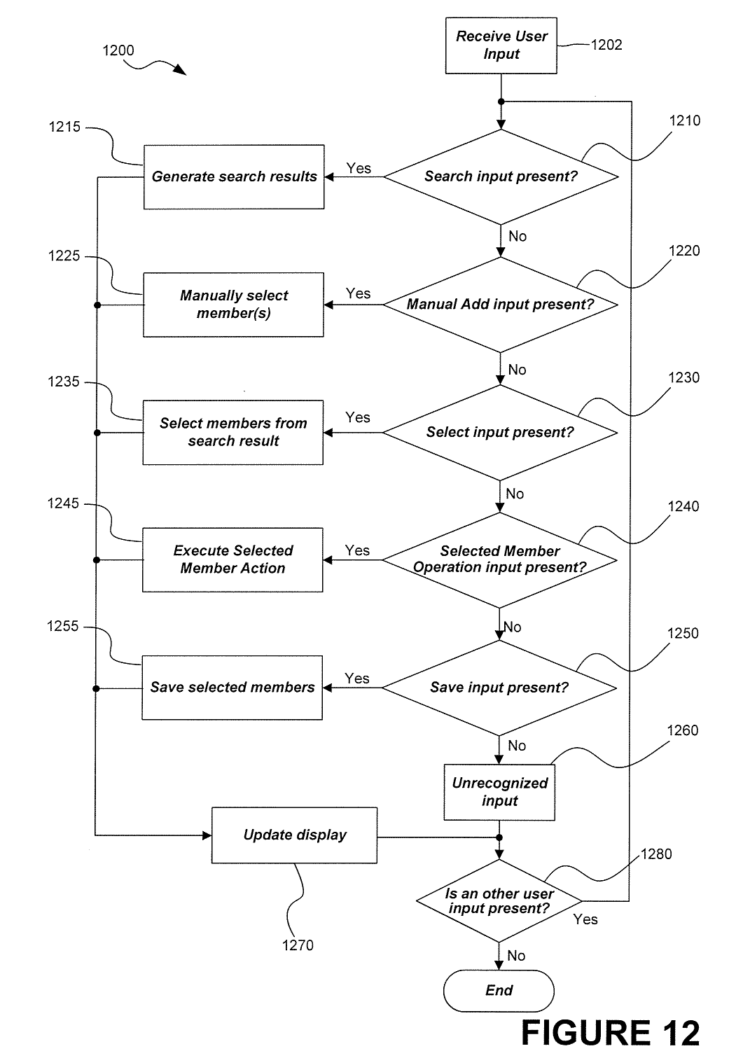

FIG. 12 presents a flow diagram 1200 of an implementation for the handling of user input. At 1202, a user input is received. The user input may be any number of commands that each may be handled differently.

At 1210, it is determined if a Search input is present. A Search input may be a command indicating that a search should be executed. In some implementations, a Search input may be the clicking one of the search buttons 714, 724, 734 or 744. If it is determined that a search input is not present, the flow diagram 1200 proceeds to 1220. However, if it is determined at 1210 that a Search input is present, at 1215 search results may be generated, after which, the flow diagram 1200 proceeds to 1270 where the display is updated.

At 1220 it is determined if a Manual Select input is present. In some implementations, a Manual Select input may include the user clicking the add button 250. In other implementations, a Manual Select input may include the user right clicking a highlighted member to bring up a context menu 900. If it is determined that a Manual Select input is not present, the flow diagram 1200 proceeds to 1230. However, if it is determined at 1220 that a Manual Select input is present, at 1225 members are manually selected, after which, the flow diagram 1200 proceeds to 1270 where the display is updated.

At 1230 it is determined if a Select Found input is present. Rather than a selection based on a relation to other members, the found member selection controls 270 may allow a selection based on the results of a search through use of a Select Found input. If it is determined that a Select Found input is not present, the flow diagram 1200 proceeds to 1240. However, if it is determined at 1220 that a Select Found input is present, at 1235 the appropriate found members may be selected, after which, the flow diagram 1200 proceeds to 1270 where the display is updated.

At 1240 it is determined if a Selected Member Operation input is present. Once selected, various operations may be performed on the selected members to alter the manner in which they are displayed through use of a Selected Member Operation input. If it is determined that a Selected Member Operation input is not present, the flow diagram 1200 proceeds to 1250. However, if it is determined at 1240 that a Selected Member Operation input is present, at 1245 the appropriate selected member operation may be executed, after which, the flow diagram 1200 proceeds to 1270 where the display is updated.

At 1250 it is determined if a Save input is present, by, for example, the user selecting the Save button 280. If it is determined that a Save input is not present, the flow diagram 1200 proceeds to 1260. However, if it is determined at 1250 that a Save input is present, at 1255 the list of selected members is saved, after which, the flow diagram 1200 proceeds to 1270 where the display is updated.

If the flow diagram reaches 1260, an unrecognized input is present and no action is taken. The flow diagram 1200 then precedes to 1280. At 1280, it is determine whether another user input is present. If an additional user input is present, the flow diagram returns to 1210 to detenmine the handling of the next user input. If no additional user input is present, the flow ends.

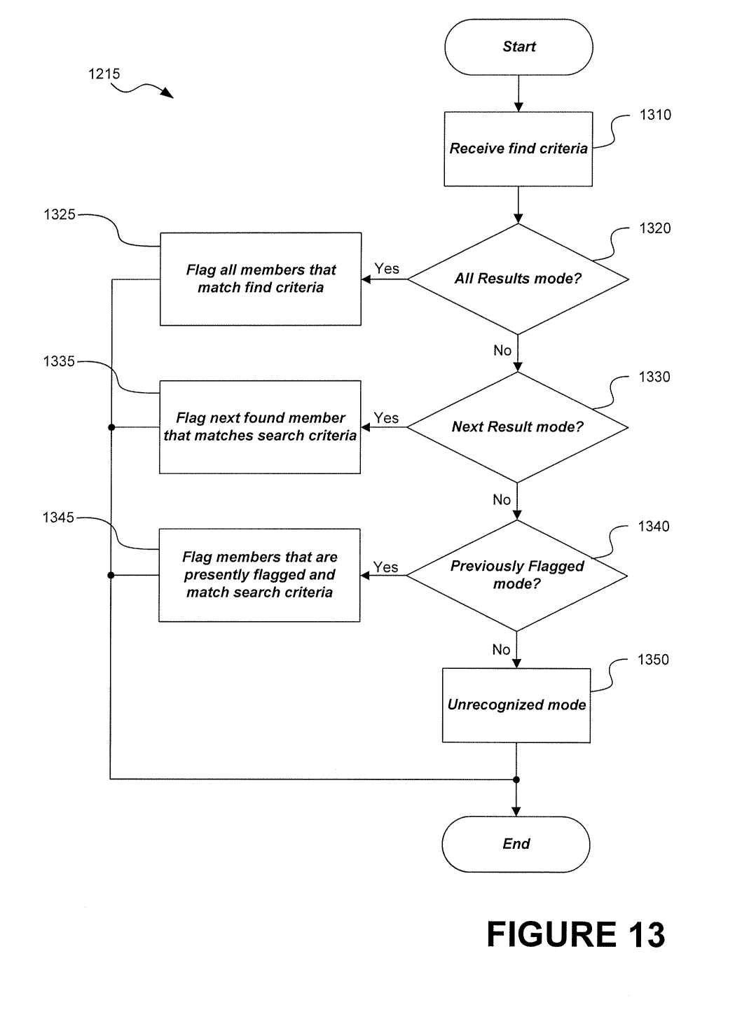

FIG. 13 presents a flow diagram 1215 of an implementation for the generating search results. At 1310, find criteria are received. Find criteria may be used to define the relation between inputted text and the result desired. For example, find criteria may require that information associated with a member must begin with the inputted text, must contain the inputted text, or must end with the inputted text or other standard find criteria known to those skilled in the art. At 1320, it is determined whether a user has set the find options in an All Results mode, by, for example, selecting a Find All button 263. If it is determined that the user has not set the find options in an All Results mode, the flow diagram 1215 proceeds to 1330. However, if it is determined at 1320 that the user has set the find options in an All Results mode, the flow continues to 1325 where all members that match the search criteria received may be flagged.

At 1330, it is determined whether a user has set the find options in a Next Result mode, by, for example, selecting a Find Next button 261. If it is determined that the user has not set the find options in a Next Result mode, the flow diagram 1215 proceeds to 1340. However, if it is determined at 1330 that the user has set the find options in a Next Result mode, the flow continues to 1335 where the next found member that matches the search criteria received may be flagged.

At 1340, it is determined whether a user has set the find options in a Previously Flagged mode, by, for example, selecting a Find Within button 262. If it is determined that the user has not set the find options in a Previously Flagged mode, the flow diagram 1215 proceeds to 1350. However, if it is determined at 1340 that the user has set the find options in a Previously Flagged mode, the flow continues to 1345 where the members that are presently flagged and that match the received search criteria received are flagged. If the flow diagram 1215 reaches 1350, an unrecognized find options mode has been selected, and no members are flagged.

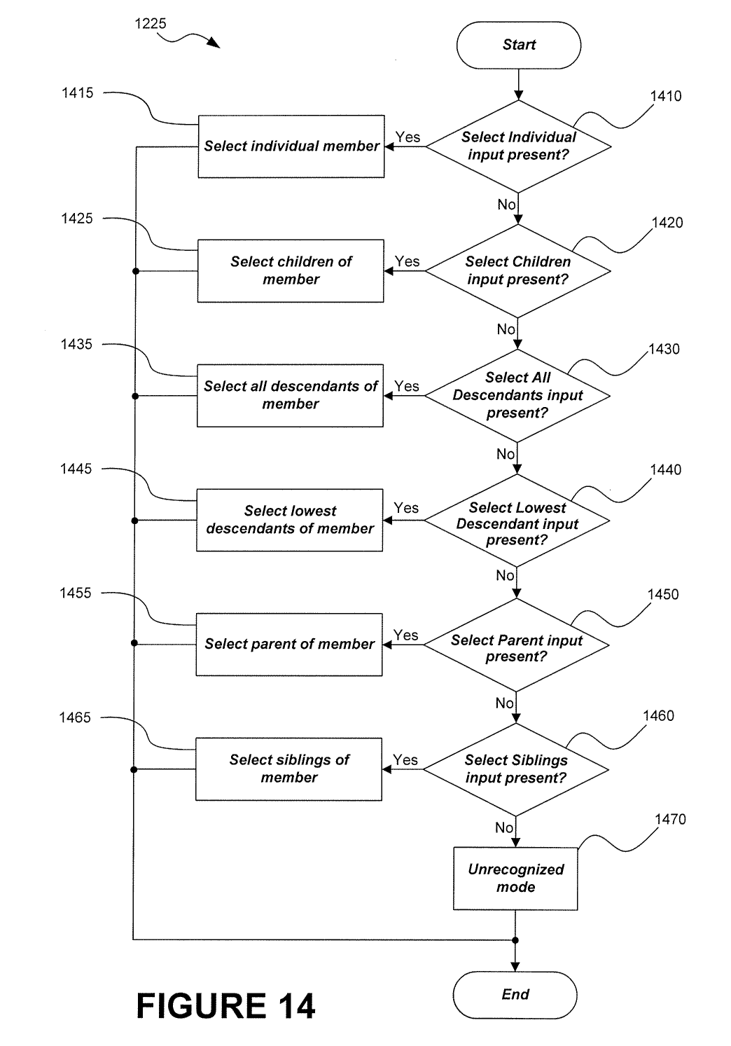

FIG. 14 presents a flow diagram 1225 of an implementation for manually selecting members. At 1410, it is determined whether a Select Individual input is present, by, for example, choosing the “Select individual member” option 810 or 910. If a Select Individual input is not present, the flow diagram 1225 proceeds to 1420. However, if it is determined at 1410 that a Select Individual input is present, at 1415 the highlighted member may be individually selected.

At 1420, it is determined whether a Select Children input is present, by, for example, choosing the “Select children of member” option 820 or 920. If it is determined that a Select Children input is not present, the flow diagram 1225 proceeds to 1430. However, if it is determined at 1420 that a Select Children input is present, at 1425 the children of the highlighted member may be selected.

At 1430, it is determined whether a Select All Descendants input is present, by, for example, choosing the “Select all descendants of member” option 830 or 930. If it is determined that a Select All Descendants input is not present, the flow diagram 1225 proceeds to 1440. However, if it is determined at 1430 that a Select All Descendants input is present, at 1435 all of the descendants of the highlighted member may be selected.

At 1440, it is detennined whether a Select Lowest Descendants input is present, by, for example, choosing the “Select lowest descendants of member” option 840 or 940. If it is determined that a Select Lowest Descendants input is not present, the flow diagram 1225 proceeds to 1450. However, if it is determined at 1440 that Select Lowest Descendants input is present, at 1445 the lowest descendants of the highlighted member may be selected.

At 1450, it is determined whether a Select Parent input is present, by, for example, choosing the “Select parent of member” option 850 or 950. If it is determined that a Select Parent input is not present, the flow diagram 1225 proceeds to 1460. However, if it is determined at 1450 a Select Parent input is present, at 1455 the parent of the highlighted member may be selected.

At 1460, it is determined whether a Select Siblings input is present, by, for example, choosing the “Select siblings of member” option 860 or 960. If it is determined that a Select Siblings input is not present, the flow diagram 1225 proceeds to 1470. However, if it is determined at 1470 that a Select Siblings input is present, at 1465 the siblings of the highlighted member are selected. If the flow diagram 1225 reaches 1470, an unrecognized select options mode has been chosen, and no members are selected.

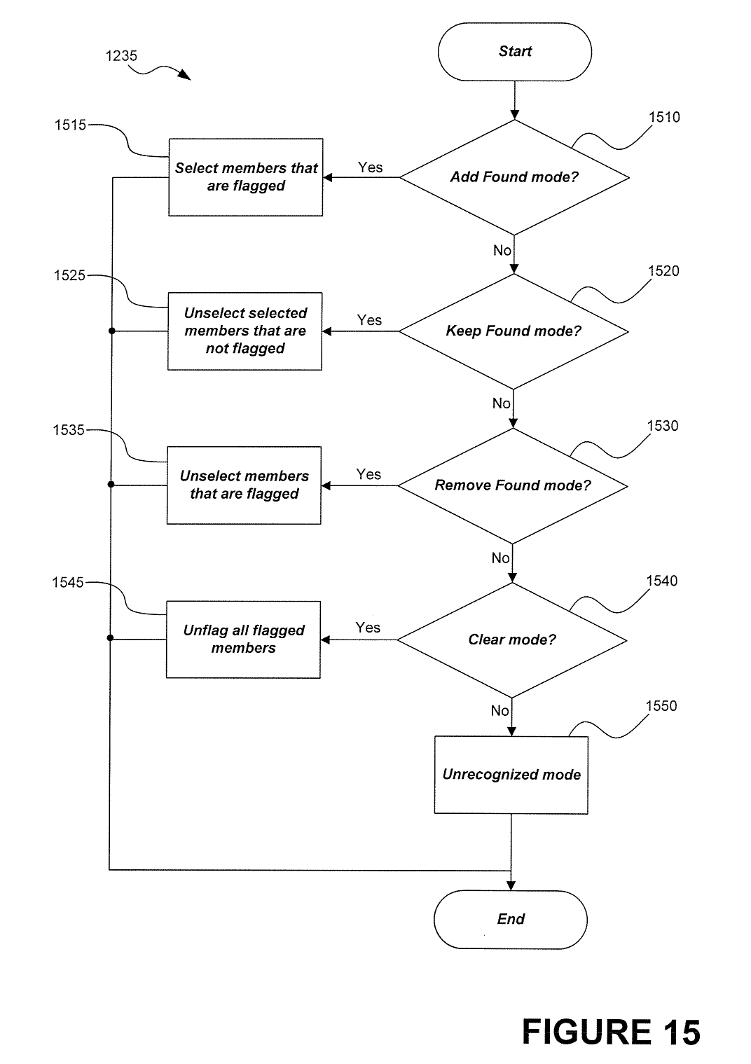

FIG. 15 presents a flow diagram 1235 of an implementation for selecting found members. At 1510, it is determined whether an Add Found input is present, by, for example, the user clicking the Add Found button 271. If it is determined that an Add Found input is not present, the flow diagram 1235 proceeds to 1520. However, if it is determined at 1510 that an Add Found input is present, at 1515 the members flagged may be selected.

At 1520, it is determined whether a Keep Found input is present, by, for example, the user clicking the Keep Found button 272. If it is determined that a Keep Found input is not present, the flow diagram 1235 proceeds to 1530. However, if it is determined at 1520 that a Keep Found input is present, at 1525 the selected members that are not flagged are unselected.

At 1530, it is determined whether a Remove Found input is present, by, for example, the user clicking the Remove Found button 273. If it is determined that a Remove Found input is not present, the flow diagram 1235 proceeds to 1540. However, if it is determined at 1530 that a Remove Found input is present, at 1535 the members flagged may be unselected.

At 1540, it is determined whether a Clear input is present, by, for example, the user clicking the Clear button 281. If it is determined that a Clear input is not present, the flow diagram 1235 proceeds to 1550. However, if it is determined at 1540 that a Clear input is present, at 1545 the selected members are unselected. If the flow diagram 1235 reaches 1550, an unrecognized input is present, and no change to the members selected is be made.

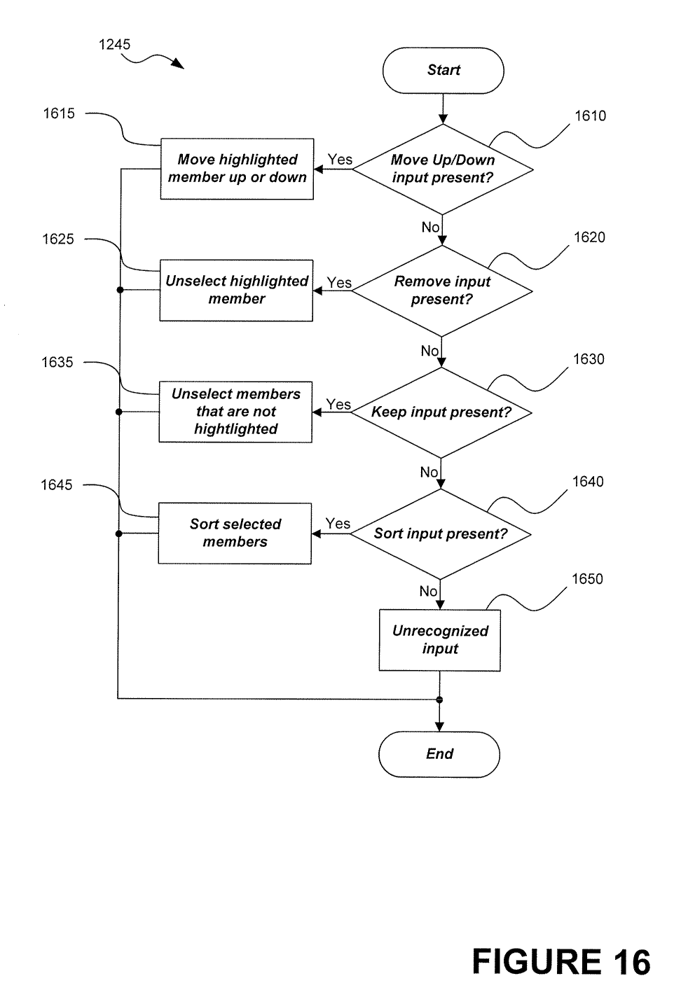

FIG. 16 presents a flow diagram 1245 of an implementation for executing a selected member operation. At 1610, it is determined whether a Move Up/Down input is present, by, for example, the user clicking Move Up/Down buttons 292. If it is determined that a Move Up/Down input is not present, the flow diagram 1245 proceeds to 1620. However, if it is determined at 1610 that a Move Up/Down input is present, at 1615 the highlighted member may be moved up or down in the selected members pane 230.

At 1620, it is determined whether a Remove input is present, by, for example, the user clicking the Remove button 293. If it is determined that a Remove input is not present, the flow diagram 1245 proceeds to 1630. However, if it is determined at 1620 that a Remove input is present, at 1635 the highlighted member may be unselected.

At 1630, it is determined whether a Keep input is present, by, for example, the user clicking the Keep button 294. If it is determined that a Keep input is not present, the flow diagram 1245 proceeds to 1640. However, if it is determined at 1630 that a Keep input is present, at 1635 the selected members that are not highlighted may be unselected.

At 1640, it is determined whether a Sort input is present, by, for example, the user clicking the Sort button 295. The user may use the sort button to order the members alphabetically, by a property value, by hierarchical relationship or any other sortable property that members may be associated with. Additionally, a blank space may be inserted between members. If it is determined that a Sort input is not present, the flow diagram 1245 proceeds to 1650. However, if it is determined at 1640 that a Sort input is present, at 1645 the order the selected members are displayed in the selected members pane 230 may be appropriately modified.

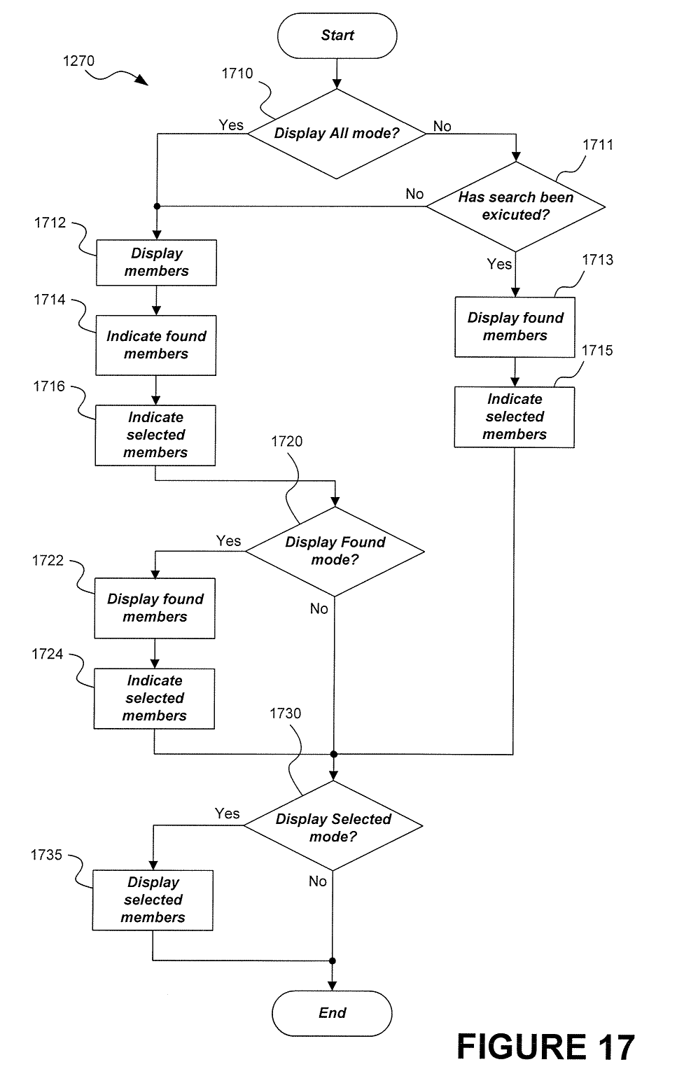

FIG. 17 presents a flow diagram 1270 of an implementation for updating the display. At 1710 it is detennined whether the Display All mode is set. This mode may either be set by the user or be predetermined. If it is determined at 1710 that the Display All mode is set, the flow diagram 1270 proceeds to 1712 to display the members 240 as described above in relation to members pane 210. At 1712, the members 240 are displayed by displaying member name. In other implementations, more information may also be displayed at 1712 such as properties associated with members and a hierarchical relationship between members. Once the members 240 are displayed, the flow diagram proceeds to 1714 to indicate found members.

Members that are flagged may be indicated in a number of ways. For example, members that are flagged may be displayed in bold. In other examples, an icon may be used to indicate a member is flagged. In still other examples, text-based indication may be used to indicate a member is flagged. Once the found members are indicated, the flow diagram proceeds to 1716 to indicate the selected members. Members that are selected may be indicated in a number of ways. For example, members that are selected may contain a check box icon that is checked. In other examples, selection may be indicated through font format. In still other examples, text based indication may be used to indicate a member is selected. Following the indication of selected members at 1716 the flow diagram proceeds to 1720.

On the other hand, if it is determined at 1710 that the Display All mode is not set, the flow diagram proceeds to 1711 to determine whether a search has been performed. If a search has not been performed, the flow diagram proceeds to 1712 and the members are displayed as discussed above. On the other hand, if a search has been performed, the flow diagram proceeds to 1713 to display only the found members, such as described above in relation to alternative members panes 1010 or 1110. There, only members flagged are displayed. Additionally, other information associated with the members such as property and hierarchy information may also be displayed. After the members flagged are displayed, the flow diagram flows to 1715 to indicate the selected members. Members that are selected may be indicated in a number of ways. For example, members that are selected may contain a check box icon that is checked. In other examples, selection may be indicated through font format. In still other examples, text based indication may be used to indicate a member is selected. Following the indication of selected members at 1715 the flow diagram proceeds to 1730.

At 1720, it is determined whether the Display Found mode is set. This mode may either be set by the user or be predetermined. A user may control whether or not the Display Found mode is set by clicking, for example, on the Hide Details button 284. If it is determined at 1720 that the Display Found mode is set, the flow diagram 1270 proceeds to 1722 to display the members 240 as described above in relation to found members pane 220. At 1722, the found members are displayed by displaying member name. In other implementations, more information may also be displayed at 1722 such as properties associated with members. Once the members are displayed, the flow diagram proceeds to 1724 to indicate the selected members. Members that are selected may be indicated in a number of ways. For example, members that are selected may contain a check box icon that is checked. In other examples, selection may be indicated through font format. In still other examples, text based indication may be used to indicate a member is selected. Following the indication of selected members at 1724 the flow diagram proceeds to 1730.

At 1730, it is determined whether the Display Selected mode is set. This mode may either be set by the user or be predetermined. A user may control whether or not the Display Selected mode is set by clicking, for example, on the Hide Details button 286. If it is determined at 1720 that the Display Selected mode is set, the flow diagram 1270 proceeds to 1735 to display the members as described above in relation to selected members pane 230. At 1735, the selected members are displayed. Following either 1730 or 1735, the flow diagram proceeds to 1280.

The availability of the features described above and the manner in which the interface is displayed may depend on a number of factors surrounding the instantiation of the interface. For example, the member selector may function differently based on the tasks the member selector is called to perform, such as selecting a default member, selecting a set of members for a rule, selecting members for workflow definition, or selecting members to construct a report or form. Further, the above features' availability and the manner in which the member selector is displayed may also depend on other factors, such as the properties of the members themselves or the type of demission being selected.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer implemented method for selecting members of a dimension of a database, the method comprising:
displaying members of the dimension by displaying names of the members of the dimension and property information associated with each of the members of the dimension;
providing a selection interface to select at least one member of the dimension while continuing to display the members of the dimension; and
providing an indication that the at least one selected member has been selected.

2. The computer implemented method of claim 1, wherein the displaying the members of the dimension further comprises indicating a hierarchical relationship between members.

3. The computer implemented method of claim 1, further comprising:
presenting a pane to display members of the dimension;
executing a search of the members of the dimension based on a search condition;
updating the pane to display only members of the dimension that satisfy the search conditions.

4. The computer implemented method of claim 1, further comprising:
executing a search of the members of the dimension based on a search condition;
displaying members of the dimension that satisfy the search conditions while continuing to display the members of the dimension.

5. The computer implemented method of claim 4, further comprising:
presenting a first pane to display members of the dimension; and
presenting a second pane to display members of the dimension in response to the search.

6. The computer implemented method of claim 5, further comprising presenting a third pane to displaying the at least one selected member of the dimension.

7. The computer implemented method of claim 4, wherein the selection interface is configured to select at least one member of the dimension that satisfies the search condition.

8. The computer implemented method of claim 1, wherein the selection interface is configured to unselect at least one member of the dimension that satisfies the search condition.

9. The computer implemented method of claim 1, wherein the providing an indication that the at least one selected member has been selected includes providing a check box icon associated with the at least one selected member.

10. A computer readable medium having computer executable instructions for selecting a member of a dimension, comprising:
displaying members of a dimension in a window;
executing a search of the members of the dimension based on a search condition;
flagging members of the dimension that satisfy the search condition;
displaying the flagged members of the dimension in the window;
providing a selection interface to select at least one member of the dimension; and
indicating in the window the at least one selected member of the dimension.

11. The computer readable medium of claim 10, further comprising:
presenting a first pane in the window to display members of the dimension;
presenting a second pane in the window to display members of the dimension in response to the search; and
presenting a third pane in the window to display the at least one selected member of the dimension.

12. The computer readable medium of claim 10, wherein the selection interface is configured to select a flagged member of the dimension.

13. The computer readable medium of claim 10, wherein the selection interface is configured to unselect a member of the dimension that is not flagged.

14. The computer readable medium of claim 10, wherein the selection interface is configured to unselect a member of the dimension that is flagged.

15. The computer readable medium of claim 10, wherein the selection interface is configured to save a list of selected members of the dimension.

16. The computer readable medium of claim 10, wherein the selection interface is configured to select a member based on a hierarchical relationship to another member.

17. The computer readable medium of claim 10, further comprising:
receiving a modification to the members of the dimension; and
updating selection of a member based on the hierarchical relationship in response to the received modification to the members of the dimension.

18. A user interface for a computer system, comprising:
a window to display members of a dimension by
displaying names of the members of the dimension,
displaying property info associated with members of the dimension,
indicating members of the dimension that are selected, and
indicating members of the dimension that have been found in response to an executed search;
a selection interface to select at least one member of the dimension; and
a search interface to search the members of the dimension based on a search condition.

19. The user interface of claim 18, further comprising:
a first pane in the window to
display names of the members of the dimension,
display property information associated with the members of the dimension,
indicate members of the dimension that are selected, and
indicate members of the dimension that satisfy the search condition; and
a second pane in the window to display members of the dimension that satisfy the search.

20. The user interface of claim 19, further comprising a third pane in the window to display members of the dimension that have been selected.
